(19) United States
(12) Patent Application Publication
(10) Pub. No.: US 2009/0114396 A1
(43) Pub. Date: May 7, 2009

(54) Wellsite measurement and control while producing device

(76) Inventors: David John Kusko, Houston, TX (US); Gabor Vecseri, Houston, TX (US); Daniel Maurice Lerner, Missouri City, TX (US)

Correspondence Address: GUERRY LEONARD GRUNE, 784 S VILLIER CT., VIRGINIA BEACH, VA, 23452, US

(21) Appl. No.: 11/982,813

(22) Filed: Nov. 5, 2007

(51) Int. Cl. E21B 34/08; F16K 47/04; F16L 55/027

(52) U.S. Cl. 166/373; 166/66; 166/177.2; 137/489

(57) ABSTRACT

Disclosed is a device, method and system for a measurement while producing (MWP) and flow throttling (FTD) device for placement in a pipe with liquid or gas flowing through it such as an oil or gas well's wellhead, casing, tubing, or horizontal or lateral passage which is responsive to the flow of fluid through it. The MWP/FTD device can create pressure pulses through the production fluid or otherwise send signals to provide bit data that are read and analyzed at the wellhead or externally thru wireless communications. The data analysis provides information regarding pressure, fluid flow, and type of fluid/gas flowing primarily within the lateral passages or generally anywhere the MWP/FTD is situated. The device helps identify whether the pipe, lateral or other passage should remain open, closed or restricted. This identification occurs by use of either autonomous control and sensors within the device and/or pre-programmed or wirelessly controlled signals that are transmitted from the well head (or externally) to the MWP/FTD. The MWP/FTD is subsequently urged to regulate the fluid/gas flow.

### FIELD OF DISCLOSURE

In the field of oil and gas production where one or several formations or laterals allow oil, gas and water to flow through into a central completed wellbore. This invention relates to a flow responsive measurement while producing (MWP) pulse-generating device and more particularly, to a flow throttling device (FTD) which responds to temperature, pressure, flowrate, etc. conditions in the wellbore. The MWP/FTD is used to reduce the flow from a high pressure to a low pressure area. More particularly, this invention relates to MWP/FTDs that would be suitable for identifying and controlling or throttling the flow rate of liquid, gas, oil or water primarily in laterals or different formations for the maximization of the production of hydrocarbons.

1. Background of Disclosure

In the general process for drilling and production of oil and gas wells a well bore would be constructed. A production casing that is a smaller diameter than the wellbore would be then lowered into the wellbore. The annular area created by the difference of the internal diameter of the wellbore and the exterior diameter of the production casing would then be filled with a cement mixture.

After drilling and casing the well, it must be ‘completed’. Completion is the process in which the well is enabled to produce oil or gas.

In many cased-hole completions, explosive charges make small holes called perforations that are made in the portion of the production casing next to the reservoir containing hydrocarbons to provide a path for the hydrocarbons to flow from the surrounding rock into the production tubing. In some completions, slotted liners are installed in the wellbore adjacent to the formations containing hydrocarbons for production directly through these slots. These slotted liners maintain the structural integrity of the wellbore in the absence of cemented casing, while still allowing flow from the reservoir into the wellbore.

After a flow path is made, acids, proppants and fracturing fluids are pumped into the well to fracture, clean, or otherwise prepare and stimulate the reservoir rock to optimally produce hydrocarbons into the wellbore.

Finally, the area above the reservoir section of the well is sealed off inside the casing, and connected to the surface via a smaller diameter pipe called tubing. This arrangement provides a redundant barrier to leaks of hydrocarbons or channeling of water.

In some applications, wellbores include several horizontally or off vertical paths commonly known as “laterals” that enhance oil and gas production. These laterals may be at several depths of the wellbore and may produce hydrocarbons simultaneously.

The collection of valves at the surface is called the “Christmas Tree”. These valves regulate pressures and flowrates, and allow access to the wellbore in case further completion work needs to be performed. From the outlet valve of the Christmas Tree, the flow can be connected to a distribution network of pipelines and tanks to supply the product to refineries, natural gas compressor stations, or oil export terminals.

A problem with controlling the well production at the Christmas Tree is the reservoir may be filling with a fluid other than what is desired to be produced. For example the reservoir may be filling with water when it is desired to produce oil. This is usually due to producing the well too quickly or from the wrong formation or lateral.

Methods to reduce water production from the laterals/different formations include sending & receiving control signals and electronic sensors coupled to valving devices downhole that selectively restrict the fluid flow of the laterals. In either case these measurement methods and valving devices require electronics and cabling down the wellbore and into the laterals. Failure of the cabling, measurement devices or valving requires costly production down time and replacement, especially subsea and in wells with many laterals.

As oil production becomes more challenging more lateral wells are being created that are connected to a single completed production well. For example, in the oil reserves of Troll, a total of 105 wells have been drilled. A third of these are so-called multi-lateral wells. In this way more oil pockets in the reservoir can be reached while reducing costs. These wells use wires to provide power to control and sensor mechanisms downhole. They are restricted to 3-5 wires per well, as they can become entangled with each other.

Therefore, there is a need for a flow throttling device (FTD) for lateral passages which does not require cabling, would provide information in a data bit stream uphole as to what fluid each lateral passage is producing and at what rate and to selectively regulate the fluid flow in the lateral passages thereby enhancing the movement of desired fluids within a single or multiplicity of lateral passages under varying degrees of pressure differential within the well.

2. Relevant Art

U.S. Pat. No. 3,790,124, to Ellett, James R., and unassigned, describes a valve actuator for actuating a valve in response to a condition which may be above a maximum allowable condition, below a minimum allowable condition or therebetween, comprising a means for sensing the condition; a transfer means operatively connected to the sensing means; an actuating means operatively connected to the transfer means; a first adjustment means for positively setting the minimum allowable condition with respect to the actuating means and a second adjustment means for positively setting the maximum allowable condition with respect to the actuating means and independently of the first adjustment means; whereby the actuating means will operate on the valve such that the valve will respond identically to the below-minimum and above-maximum conditions.

U.S. Pat. No. 3,838,711, to Ellett, James R., and assigned to Bralome Resources Limited, describes a valve assembly comprising a pilot and a valve actuator. The pilot has an annular body member including an inlet port, a signal port and an exhaust port communicating through the body member with an inlet chamber, a signal chamber and an exhaust chamber respectively. Additionally having a dual poppet comprising an inlet poppet portion in the inlet chamber, a signal poppet portion in the signal chamber and pin means rigidly joining the portions. There is a fluid passageway communicating between the inlet and signal chambers, an annular guide means positioned between the signal and exhaust chambers and valve actuating means slidably sealed within the guide means. The valve actuator includes a sensing means for sensing a condition, transfer means operatively connected to the sensing means with the actuator means operatively connected to the transfer means and to the actuating means and a plurality of adjusting means for setting a maximum allowable and a minimum allowable condition for response of the valve, the response of the valve at the maximum condition being identical to the response of the valve at the minimum condition.

U.S. Pat. No. 4,391,152, to Ellett, James R., and assigned to Bralome Resources Limited, describes a sampling device for taking fluid samples. The device comprises a probe adapted to extend into fluid and to act as an intake port, a housing connected to the probe, a first valve means in the housing adapted to allow admittance of a portion of the fluid, a second valve means adapted to allow exit of the admitted fluid to a storage container, a sample holding means adapted to hold a predetermined amount of the admitted fluid. There is an actuating means adapted to open and close the first and second valve means at predetermined intervals to allow for the admittance and exit of the fluid, respectively, and a substantially uninterrupted passageway for the fluid extending through the housing and probe. The passageway is adapted to allow for the admission of cleaning means to clean the passageway without disassembly of the probe and housing.

U.S. Pat. No. 4,423,748, to Ellett, James R., and assigned to Bralome Resources Limited, describes an emergency shut down device for a reciprocable valve comprising a base member for connecting the device to a valve housing with the member having a central bore therethrough. A spring cartridge assembly including a generally cylindrical container having first plate means at one end, second plate means at the other end, an opening in the first plate means to receive the base member, an opening in said second plate means of a diameter greater than that of the first-mentioned opening, annular ring means in the container and compression spring means between the first plate means and the ring means. An annular ram cup connected to and extending from the ring means toward the first plate means with the ram cup having a closure plate provided with a central opening, at the end distant from the ring means. A cap member is also connected to the exterior of the second plate means to cover the second-mentioned opening and a cylinder is connected to and extending from the cap member into the interior of the ram cup. There is additionally a piston means sealingly slidable within the cylinder; a stem means connected at one end to the ram cup and extending through the central opening in the ram cup with the interior of the assembly and the bore in the base member for connection to the reciprocable valve and an inlet means in the cap member for admitting fluid under pressure to a chamber formed in the cylinder between the cap member and the piston. The fluid under pressure in the chamber will move the piston to abut the ram cup and then move the ram cup to extend the stem means from the base member and to simultaneously compress the spring with a loss of pressure permitting the spring to rapidly return the ram cup, piston and stem to an unextended condition.

U.S. Pat. No. 4,589,493, to Kelly, et. al., and assigned to Cameron Iron Works, Inc., describes a subsea wellhead production apparatus comprising a subsea production flowline body having first and second passages opening on a surface of the body and a means surrounding the body surface for coacting with a connecting means. There is a choke body having an inlet and an outlet extending therein from one of its surfaces and means surrounding the surface for co-acting with a connecting means in the choke body for conducting flow from the inlet through a valve seat to the outlet with a valve member movably mounted in the body to co-act with the valve seat to control flow through the valve seat. Additionally there is a means for moving the valve member with respect to the valve seat and a remotely actuated means for releasably connecting the co-acting means of the choke body to the co-acting means of the flowline body with the first passage in communication with the inlet and the second passage in communication with the outlet whereby flow from the first passage to the second passage is controlled by the valve member.

U.S. Pat. No. 4,825,895, to Maltman, Michael, and assigned to Chevron Research Company, describes a valve for reducing the pressure of fluid consisting essentially of a hollow, elongated cylindrical body having a horizontal axis, a cylindrical sliding sleeve member adapted to fit inside the body in a close-fitting relationship therewith, the sliding plug sleeve having an aperture along its longitudinal axis and the aperture having a restricted portion which converges then diverges in a gentle sweeping fashion. Also, a plug, having a face that will substantially coincide with the restricted portion when the restricted portion is pressed against the plug, and further comprising a first flow passage oriented to have its axis substantially parallel to the horizontal axis and the plug member attached to the body at a first end. A sliding sleeve sealing means is mounted on a second end of the body member with the sliding sleeve sealing means having a second flow passage therein and the body, plug, and sliding sleeve forming a first pressure control chamber. Additionally the body, sliding sleeve sealing means, and sliding sleeve forms a second pressure control chamber with a means for selectively increasing and decreasing pressure in the first and the second pressure control chamber such that the restricted portion can be selectively moved along the horizontal axis and against the plug member to seal the first flow passage.

U.S. Pat. No. 4,830,122, to Walter, Bruno H., and assigned to Intech Oil Tools Ltd, describes a flow pulsing apparatus adapted to be connected in a drill string above a drill bit and including a housing providing a passage for a flow of drilling fluid toward the bit, turbine means in said housing rotated about an axis by the flow of drilling fluid, and valve means operated by said turbine means for periodically restricting the flow through the passage in a cyclical manner to create pulsations in the flow and a cyclical water hammer effect to vibrate the housing and the drill bit during use. The valve means including a valve member which is reciprocated in response to rotation of the turbine means to effect the periodic and cyclical restriction of the flow.

U.S. Pat. No. 4,848,473, to Lochte, Glen E., and assigned to Chevron Research Company, describes an apparatus for a subsea well completion comprising a wellhead connector having a tubing flow passageway in fluid communication with a well tubing and an annulus passageway in fluid communication with a well annulus, a tubing connection conduit having a first end operatively connected to the wellhead connector and in fluid communication with the tubing flow passageway and further comprising a tubing shut-off valve. There is an annulus connecting conduit having a first end operatively connected to the wellhead connector and in fluid communication with the annulus flow passageway and further comprising an annulus shut-off valve. An annulus wing conduit is connected to the annulus connecting conduit above the annulus shut-off valve and further comprising an annulus wing conduit shut-off valve with a treecap connected to a second end of the tubing connecting conduit and the annulus connection conduit. The treecap further comprises a production stream conduit connected at a first end to the treecap and the tubing connection conduit; a pressure control valve connected to a second end of the production steam conduit; a production return conduit connected at a first end to the pressure control valve and at a second end to the treecap and a tubing wing conduit connected to the treecap and the production return conduit further comprising a tubing wing conduit shut-off valve.

U.S. Pat. No. 4,961,560, to Ellett, James R., and assigned to Bralome Resources Limited, describes a latching trip valve comprising a spindle longitudinally movable within a housing, a lever rotatably connected to the spindle and operable to move the spindle longitudinally relative to the housing upon rotation of the lever, a pilot piston connected to the spindle, an O-ring between the piston and the spindle, a spring loaded floating seat movable relative to the housing by the O-ring and the pilot piston, a passageway between the spindle and the floating seat, with the passageway being opened and closed by movement of the pilot piston relative to the floating seat.

U.S. Pat. No. 5,070,900, to Johnson, Clarence W., and assigned to Bralome Resources Limited, describes a pressure monitoring system for a pipeline comprising a signal circuit having hydraulic fluid at a first pressure, an actuator circuit having hydraulic fluid at a second pressure, a pressure reducing valve between the actuator and the signal circuit, a pilot in operative relationship with the pipeline. The pilot is movable between a first position when pressure in the pipeline is within predetermined operating limits and a second position when the pressure in the pipeline is outside of the operating limits. An accumulator maintains the signal circuit at a substantially constant pressure in association with the pressure reducing valve when the hydraulic fluid flowing between the signal and actuator circuits and the accumulator is operable to receive fluid from and discharge fluid to the signal circuit wherein the first pressure of the signal circuit is lower than the second pressure of the actuator circuit.

U.S. Pat. No. 5,205,361, to Farley, et. al., and assigned to Completion Services, Inc., describes an improved traveling disc valve assembly for allowing increased production flow to the surface comprising a length of tubing lowered down a cased wellbore, a crossover tool secured to the lower end of the length of tubing, a disc valve assembly secured to the crossover tool and positioned to a lower circulation position in the well bore. The assembly further comprises a disc valve secured in a bore of the assembly; a means interconnecting the crossover tool with the disc valve assembly, a means in the upper portion of the disc valve assembly for severing the disc valve assembly from the crossover tool when the disc valve assembly is moved to an upper position blocking production flow up the production string; and a means lowered into the bore of the production casing to rupture the disc valve and to disengage the disc valve assembly and push it to a position below the production screen to allow production to commence.

U.S. Pat. No. 5,213,133, to Ellett, James R., and assigned to Barber Industries Ltd., describes a pilot responsive to pressure changes comprising a base housing and an inlet in the base housing exposed to a pressure to be monitored, a diaphragm in the inlet within the base housing, a lower body operably connected to the base housing with a spool movable within a cavity in the lower body. There are inlet, exhaust and signal ports extending from the outside of the lower body to the cavity and annular grooves in the spool communicating with cross ports within the body and crossholes within the spool. A first spring biased poppet seal ring is mounted about the spool and is movable between a first position wherein the poppet seal ring contacts a first flange of the spool when the pressure is within normal operating pressure range and a second position out of contact with first flange of the spool and in contact with a first flange of the body when the pressure is one of either higher or lower than the normal operating pressure range by a predetermined amount.

U.S. Pat. No. 5,215,113, to Terry, Paul E., and unassigned, describes a flow control device for stopping the flow of fluid therethrough when there is a break or leak in the flow path downstream of the device having a housing with a first end and a second end, an inlet port located in the first end of the housing for admitting fluid to the housing with the inlet port having a cross-sectional area. Further there is an outlet port located in the second end of the housing for discharging fluid from the housing with the outlet port having a cross-sectional area. There is a cylindrical valve chamber located in the housing comprising an aperture provided in the housing such that the aperture extends from the first end of the housing toward the second end of the housing with the cylindrical valve chamber having a first end and a second end with the first end of the cylindrical valve chamber being in fluid communication with the fluid inlet port and the second end of the cylindrical valve chamber being in fluid communication with the outlet port. A washer-shaped sealing shoulder is located at the second end of the cylindrical valve chamber with a piston valve body located for reciprocating movement in the cylindrical valve chamber. The piston valve body has a plurality of longitudinally extending flow channels therethrough being oriented substantially parallel to the direction of the flow path. Each of the flow channels has an inlet with a cross-section and an outlet with a cross-section wherein a sum taken of the inlet cross-sections being greater than the cross-section of the inlet port; a sum taken of the outlet cross-sections being greater than the cross-section of the outlet port wherein the second end of the cylindrical valve chamber is blocked by the piston valve body when the body abuts the washer-shaped shoulder. Additionally there is a means for biasing the piston valve body away from the washer-shaped shoulder thereby allowing fluid entering the first end of the cylindrical valve chamber to flow through the flow channels in the piston valve body and out the second end of the cylindrical valve chamber. The piston body overcomes the biasing of the biasing means to move gradually into contact with the washer-shaped shoulder thereby sealing the cylindrical valve chamber from being in fluid communication with the outlet port with a minimum of shock when a break or leak in the flow path occurs downstream of the device. The piston valve body comprises a cylindrical element having a conical nose portion extending from a first end thereof providing a seating area that blocks the second end of the cylindrical valve chamber when the piston valve body abuts the washer-shaped shoulder and wherein the seating area comprises a continuous tapered surface that is devoid of flow channels.

U.S. Pat. No. 5,341,837, to Johnson, Clarence W., and assigned to Barber industries, Ltd., describes a two-line pilot to operatively sense the pressure in a flowline comprising a body operable to be mounted to a base housing, a pushrod movable within the base housing and body, an inlet port and an outlet port, a first poppet sleeve mounted on the pushrod, a first poppet sleeve shoulder on the inside circumference of the first poppet sleeve operable to interact with a first pushrod flange on the outside circumference of the pushrod, a spring operable on the first poppet sleeve to urge the first poppet sleeve shoulder into a contacting relationship with the first pushrod flange, a first core ring mounted about the pushrod, a first o-ring mounted on the first core ring and being operable to simultaneously contact one end of the first poppet sleeve and the inside circumference of the body. There is an inlet port operable to admit fluid to a circumferential cavity surrounding the poppet sleeve and defined on one end by the first o-ring of the core ring and at the opposite end by a seal between the body and the first poppet sleeve. An outlet port communicates with the inlet port to thereby exhaust fluid through the pilot when the first poppet sleeve is out of contact with the first o-ring of the first core ring.

U.S. Pat. No. 5,291,918, to Johnson, Clarence W., and assigned to Barber industries, Ltd., describes an actuator for opening and closing a valve comprising a manually operated pump for pumping hydraulic fluid from a reservoir holding the hydraulic fluid to move a piston and a valve operated from the piston in a first direction and at least one spring to move the piston and the valve in a second direction opposed to the first direction with the spring being contained in the reservoir.

U.S. Pat. No. 5,395,090, to Rosean, Nils O., and unassigned, describes a valve for use in a high pressure fluid system comprising a housing having a chamber therein and an inlet and an outlet; a valve assembly mounted in the housing and movable between a position opening and a position closing fluid flow from the inlet through the chamber and to the outlet. The valve assembly includes an inner cylindrical member coaxially mounted to an outer cylindrical member, the inner cylindrical member extending axially into an interior of the outer cylindrical member. The valve assembly further includes a valve member mounted between the inner cylindrical member and the outer cylindrical member with a means for selectively moving the valve assembly between the opening and closing positions. The moving means comprises utilizing pressure fluid at the inlet for moving the valve assembly to the opening position, a spring means for moving the valve to the closing position and a means for balancing the effects of inlet pressure on the valve assembly as the valve assembly is moving to the closing position. The spring means includes a first spring biasing the inner cylindrical member and the outer cylindrical member toward the closing position and a stop means engaging the valve assembly to prevent further movement of the valve assembly by the first spring. The spring means further comprises a second relatively light spring biased between the outer cylindrical member and the valve member and operable, upon the inner and outer cylindrical members and being prevented by the stop means from further movement by the first spring so as to urge the valve member to the closing position and a flexible seal means carried by the valve member and engageable with the housing to prevent fluid flow from the inlet to the outlet when the valve assembly is in the closing position.

U.S. Pat. No. 6,276,135, to Ellett, James R., and assigned to ARGUS Machine Co. Ltd., describes a hydraulic control circuit for a hydraulic actuator comprising a high-low pilot having a sensing port for connection to a flow line, a first line connecting the high-low pilot to a hydraulic actuator, the first line forming a single pressure circuit, a second line connecting the high-low pilot to a reservoir, a normally closed relief valve connected to the first line for relief of excessive pressure, a normally closed override valve connected to the first line for manual override of circuit controls and a pump connected to the first line for pressuring the first line.

U.S. Pat. No. 6,772,786, to Ellett, James R., and assigned to ARGUS Machine Co. Ltd., describes a hydraulic control circuit comprising a control line connected to a device to be controlled by fluid pressure in the control line, a time-out valve on the control line, the time-out valve having a time-out period during which time-out period operation of the time-out valve is delayed after actuation of the time-out valve, a pump connected to the control line for pressurizing the control line with fluid and an arming valve operated by pressure on an arming line connected to the control line and the arming valve being connected to the time-out valve to reduce the time-out period in response to pressure on the control line.

### SUMMARY OF THE DISCLOSURE

Disclosed is a device, method and system for a measurement while producing (MWP) and flow throttling (FTD) device for placement in an oil or gas well vertical, horizontal or lateral pipe, pipeline, wellhead, tubular or casing or passage which is responsive to the flow of fluid through a well bore or well laterals. The MWP/FTD device could create pressure pulses or use other methods (for example electrical cable, etc.) to provide bit data that are read and analyzed at the wellhead through the production fluid. The data analysis could provide information regarding pressure, fluid flow, and type of fluid flowing primarily within the lateral passages. The device helps identify whether the MWP/FTD should remain open, closed or restricted. This can be done autonomously downhole or it can be controlled by a signal that is transmitted down hole from the well head to the MWP/FTD, which in turn urges the MWP/FTD to regulate the fluid flow as desired by the operator.

One embodiment provides an MWP/FTD that may be used in the production reservoir, pipe or laterals of a completed well.

Another embodiment provides an MWP/FTD that may be calibrated to generate a pressure pulse sent up hole to the well head and identifies a pulse strength/frequency signature that will identify whether the fluid flow through a specific lateral passage is crude oil, gas or water or a mixture of any or all selected fluids.

Another embodiment provides an MWP/FTD that is used to generate internal power via the fluid flow through the MWP/FTD device by rotating a turbine system coupled to an electrical generator thereby providing electrical power to sensors, transducers and rechargeable (or not) battery(s) downhole.

Another embodiment provides an MWP/FTD that includes sensor and flow throttling capabilities for the Christmas tree valving and/or pipelines.

Another embodiment includes an MWP/FTD to provide a means of stopping the fluid flow through the MWP/FTD thereby obstructing the fluid flow within the lateral passage for example, if the lateral is producing too much water.

Another embodiment includes an MWP/FTD wherein several MWP/FTD devices are used in a producing well wherein the fluid flow composition is identified for each lateral passage and each lateral passage is producing a specific fluid flow and selected lateral passages may be obstructed by the MWP/FTD through feedback control thereby stopping undesirable fluid flow wherein only the desired fluid flow is allowed to enter into the production pipe.

Another embodiment is an MWP/FTD that is not linked mechanically or cabled electrically to the well head thereby impervious to forces of nature or acts of sabotage above ground. This MWP/FTD could be positioned slightly below the surface so that it could be pulled for service easily with a wireline and fail-safe in the closed position, thus shutting in the well. It could also be controlled by wireless communications, as could any uphole MWP/FTD in the Christmas Tree valving.

In another embodiment the MWP/FTD provides essentially four outer flow channels that allow fluid, such as oil, gas or water to flow. These channels are defined as the upper annular, the middle annular, lower annular, and centralizer annular collar flow channels. The inner lower and inner middle flow channels direct the fluid flow to the pulser assembly within the MWP/FTD. Annular flow of the MWP/FTD fluid, by the flow guide and pulser assembly, is essentially laminar, and pulse signals are generated as little pressure drops that are more detectable. Incorporation of a method and system of magnetic coupling, a concentrically located turbine, inductive coil for electrical power generation, bellows design and reduced pressure differential, collectively significantly reduces battery energy consumption when compared with conventional MWP/FTD's. Additionally, the MWP/FTD can be entirely independent of cabling and is electronically self sustaining due to its generator & rechargeable batteries/capacitors which are dependent only on presence of flow to sustain a minimal energy level to operate the system.

In an embodiment, the MWP/FTD utilizes a turbine residing near and within the proximity of a flow diverter. The flow diverter diverts fluid in an annular flow channel into and away from the turbine blades such that the force of the fluid causes the turbine blades and turbine to rotationally spin around an induction coil. The turbine may also act as a flowmeter. The induction coil generates electrical power for operating the motor and other instrumentation mentioned previously. The motor is connected to the pilot actuator assembly via a drive shaft. The pilot actuator assembly comprises a magnetic coupling and pilot assembly. The magnetic coupling comprises outer magnets placed in direct relation to inner magnets located within the magnetic pressure cup or magnetic coupling bulkhead. The magnetic coupling translates the rotational motion of the motor, via the outer magnets to linear motion of the inner magnets via magnetic polar interaction. The linear motion of the inner magnets moves the pilot assembly, comprising the pilot shaft, and pilot, linearly moving the pilot into the pilot seat. This action allows for partial or full closing of the pilot seat, pressurizing the MWP/FTD, closing the flow throttling device orifice, thereby generating a pressure pulse. Further rotation of the motor and drive shaft, via the magnetic coupling, moves the pilot assembly and pilot away from the pilot seat, depressurizing the MWP/FTD sliding pressure chamber and allowing for opening the MWP/FTD and reversing the pressure pulse.

In yet another embodiment identical operation as indicated above, of the pilot into and out of the pilot seat orifice can also be accomplished via linear to linear and also rotation to rotation motion of the outer magnets in relation to the inner magnets such that, for example, rotating the outer magnet to rotate the inner magnet to rotate a (rotating) pilot causes changes in the pilot pressure, thereby pushing the pulser/FTD up or down.

Another embodiment of the MWP/FTD pulser includes the combination of middle and lower inner flow channels, flow throttling devices, bellows, and upper and lower flow connecting channels possessing angled outlet openings that help create signals during transitioning from both the sealed (closed) and unsealed (open) positions. Additional unique features include a flow guide for transitional flow and a sliding pressure chamber designed to allow for generation of the pressure pulses. The flow throttling device slides axially on a pulser guide pole being pushed by the pressure generated in the sliding pressure chamber when the pilot is in the seated position. Increased bit rate is generated by allowing the fluid to quickly back flow through the unique connecting channel openings when the pilot is in the open position. Bi-directional axial movement of the poppet assembly is generated by rotating the motor causing magnets to convert the rotational motion to linear motion which opens and closes the pilot. It should be noted that rotary-rotary, rotary-linear, linear-rotary, and linear-linear interaction of magnets with the poppet valve of the flow throttling device are all acceptable modes of moving the pulser in a bi-directional manner. The poppet can also be activated using conventional solenoid technologies described in Teledrill's first U.S. Pat. No. 7,180,826 to Kusko, et. al., granted Feb. 20, 2007, herein fully incorporated by reference.

Another embodiment of the MWP/FTD is that each lateral has its own MWP/FTD that pulses an identifiable magnitude and frequency that may be transmitted because the pulse is developed in near-laminar flow within the uniquely designed flow channels and a repeatable water hammer effect occurs due to the small amount of time required to close the flow throttling device. Additionally, the magnitude and frequency identify a particular lateral's signature of what type of fluid is flowing through the MWP/FTD and what pressure, temperature, etc. is passing by whichever sensors that are in the MWP.

Yet another embodiment is a method for generating pressure pulses in a fluid flowing within a lateral passage that includes starting at an initial (first) position wherein a pilot (that can seat within a pilot seat which resides at the bottom of the middle inner flow channel) within a lower inner flow channel is not initially engaged with the pilot seat. The pilot is coupled in this position with the magnetic coupling. The next step involves rotating the motor, causing the magnetic fields of the outer and inner magnets to move the pilot actuator assembly thereby moving the pilot into an engaged position with the pilot seat. This motion seals a lower inner flow channel from the middle inner flow channel and forces the inner fluid into a pair of upper connecting flow channels, expanding the sliding pressure chamber, causing a flow throttling device to move up toward a middle annular flow channel and stopping before the orifice seat, thereby causing a flow restriction. The flow restriction causes a pressure pulse or change in pressure/flow that is transmitted uphole. At the same time, the fluid remains in the exterior of the lower connecting flow channels, thus reducing the pressure drop across the pilot seat. This allows for minimal force requirements for holding the pilot in the closed position. In the final position, the pilot moves back to the original or first position away from the pilot orifice while allowing fluid to flow through the second set of lower connecting flow channels within the lower inner flow channel. This results in evacuating the sliding pressure chamber as the fluid flows out of the chamber and through the lower flow connecting channels into the middle inner flow channel and eventually into the upper inner flow channel. As this occurs, the flow throttling device moves in a downward direction against the direction of the flowing fluid until the FTD is motionless. This decreases the flow throttling device created pressure restriction of the fluid flow past the flow throttling device orifice, thereby completing the pulse. By developing and/or controlling the pulse, it is possible to identify the fluid, flow rate and pressure (as a measurement while producing device) of each lateral passage within a completed well and to use the MWP/FTD (as a flow throttling device or choke), thereby restricting a lateral passage from passing unwanted fluids/gases into the wellbore as per the operator's requirements/specifications.

An alternative embodiment for this MWP/FTD assembly unit includes connecting the motor to a drive shaft through a mechanical device such as a worm gear, barrel cam face cam or other mechanical means for converting the rotational motion of the motor into linear motion to propel the pilot actuator assembly. An electronic circuit package can be used to control the motion and frequency of opening and closing the flow throttling device.

Yet another embodiment of the MWP/FTD assembly unit includes a device which includes a pulser housing or bell with ports or channels through the housing or bell itself to allow for pilot flow exhaust, adding another feature which assists in ensuring that pulsing continues if other flow channels become clogged during operation.

Yet another embodiment of the MWP/FTD assembly unit includes fine tuning of the pulse frequency and amplitude from instrumentation such as a computer at the well head.

Yet another embodiment of the MWP/FTD is the ability to ensure cable free communication wherein the data stream from the MWP portion of the MWP/FTD would be interpreted quickly and responsively with the wellhead computer/system. Higher bit rate data could be accomplished through a set of MWP/FTDs.

Yet another embodiment of the MWP/FTD is that responses to the data stream could be made manually or automatically in response to a given set of instructions depending on changes in the pressure or flow rate. Changes in both positive and negative pressure and flow rate would trigger an adaptive response.

In another embodiment the MWP/FTD requires no pumps and no displacement motors to generate a signal. Since the MWP/FTD is similar to an inverted MWD, the uphole flow from the formation into the wellbore supplants the flow of uphole pumps and provides little noise such that only a small amplitude pulse is required for the signal and that filtering is relatively easy when compared to noise reduction software needed for measurement while drilling (MWD) devices.

In another embodiment the MWP/FTD may be used in applications where there is a fluid/gas flow through a tube or chamber such as water flow acting through a dam or gas exhaust flow through a smokestack.

Additionally, an embodiment of the MWP/FTD includes the ability to control the flow of fluid &/or gas in a passage with or without the use of “christmas tree” valving at or near the well head and can be effected thru wireless transmission without the need for manual intervention Yet another embodiment of the MWP/FTD is to place several MWP/FTD's within one or several lateral passages to control several different formations depending on the desired fluid flow production from each lateral passage. In a high pressure lateral passage, several MWP/FTDs could be strung together for greater flow control of laterals within the same formation.

In another embodiment of the MWP/FTD, the use of hydraulics together with an anti-magnetic polar interaction is used to drive the flow throttling device such that magnets are located both within an extended and elongated pulser bell housing and as part of the magnet coupling assembly that is initially located below the flow throttling device. Using the magnets in this arrangement, before there is any flow, the anti-magnetic forces (caused by N-S pole alignments) push the pulser bell/flow throttling device assembly toward either an opened or closed position. In other words, the magnetic forces are always pushing against each other which allows for more regulated movement of the bell and MWP/FTD and helps ensure that there is little or no “sticking” of the position of the bell or poppet in the “dead center” position.

In yet another embodiment of the MWP/FTD, a rotational poppet is utilized. This poppet activates the flow throttling device MWP/FTD so that pulses are created. The flow is diverted directly to the turbine which rotates the turbine blades at different and/or variable speeds depending on channel dimensions as well as the design of the turbine blades themselves. It has been determined that blades with small degree angles may turn slowly enough so that control of the motion of MWP/FTD is possible without the use of gears. For example, high torque provided by the flow to the turbine could lead to a low spin speed of the blade, thereby allowing the operator freedom to choose pulse frequency and amplitude/magnitude. Pulse amplitude and rate are vitally important to both drilling speeds and/or fracturing of the formation(s).

In yet another embodiment separate flow channels can be used as a failsafe mechanism to allow flow to by-pass the MWP/FTD.

An additional embodiment is these designs can be extended to determining more information regarding the oil/gas/water fluids within a pipe by measuring the magnitude of the pulses at distances remote from the downhole bore location. Sensors which may be placed at different locations in various pipes could be used to indicate pulse magnitude, travel distance, and velocity during or in the absence of fluid flow as required by the operation.

### BRIEF DESCRIPTION OF THE DRAWINGS

FIG. 1 is an overview of the major sections and components of the MWP/FTD.

FIG. 2A is a sectional detail of the stinger and battery sections which are placed in the lateral passage toward the fluid flow.

FIG. 2B is a sectional detail continuation of FIG. 2A which includes the instrumentation, motor and chassis.

FIG. 2C is a sectional detail continuation of FIG. 2B which includes details of the motor assembly, coil, turbine and pulser assembly.

FIG. 2D is a sectional detail continuation of FIG. 2C which includes the fishing head assembly.

FIG. 3 describes the pulser system operation.

FIG. 4 describes the operation of the magnetic coupling and how the pilot is actuated.

FIG. 5 describes the bellows operation.

FIG. 6 describes the guide pole channel and orifice chamber.

FIG. 7 describes a cross section of a downhole pulse generating device in the open position.

FIG. 8 describes a downhole pulse generating device powered by a positive displacement motor or turbine with a rotating valve flow bevel.

FIG. 9 describes a downhole pulse generating device with an alternate valving for filling the pressure chambers.

FIG. 10 describes a downhole pulse generating device where the inner and outer magnets are contained within the flow throttling device.

### DETAILED DESCRIPTION OF THE DRAWINGS

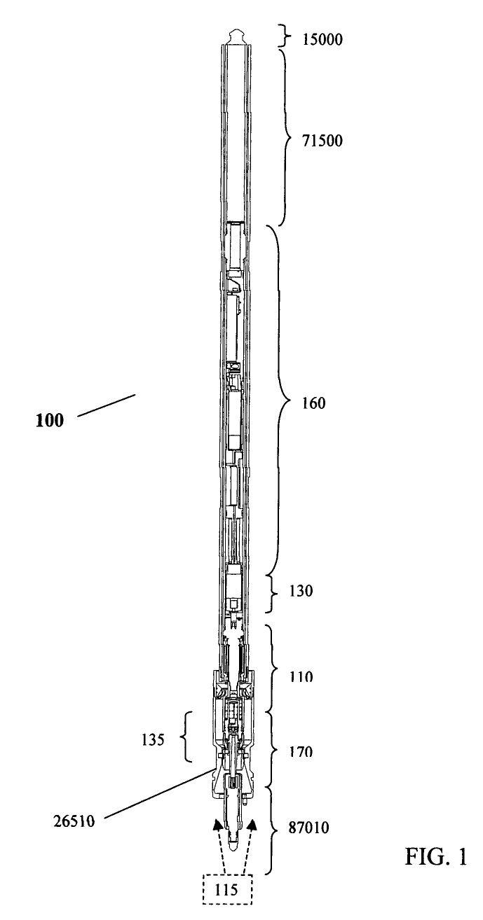

FIG. 1 is an overview of the major sections and components of the MWP/FTD [100]. Beginning at the bottom of FIG. 1 and working up in the flow direction is the stinger [87010], pulser assembly [170], turbine [110], motor [130], various instruments [160], battery [71500], and fishing head assembly [15000]. The pulser assembly [170] comprises a flow throttling device [26150] and poppet actuator assembly [135]. Of note, when MWP/FTD [100] is placed in the lateral passage (not shown), the fluid [115] (oil, gas or water or combination) enters into the stinger [87010] and exits the fishing head assembly [15000].

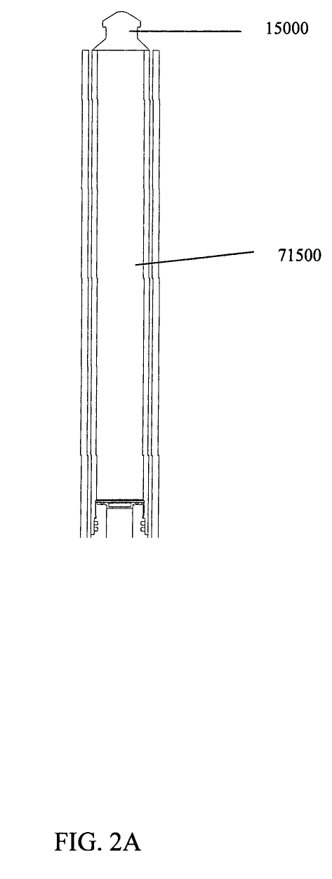

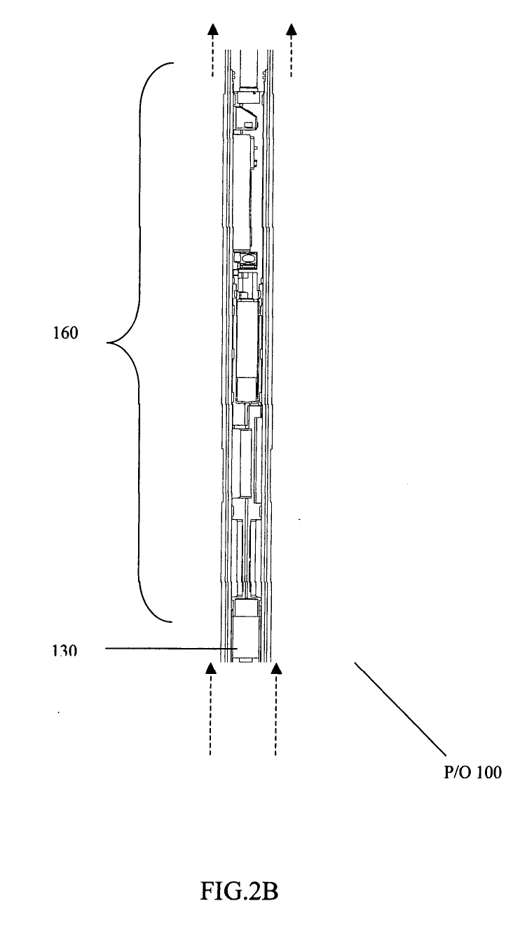

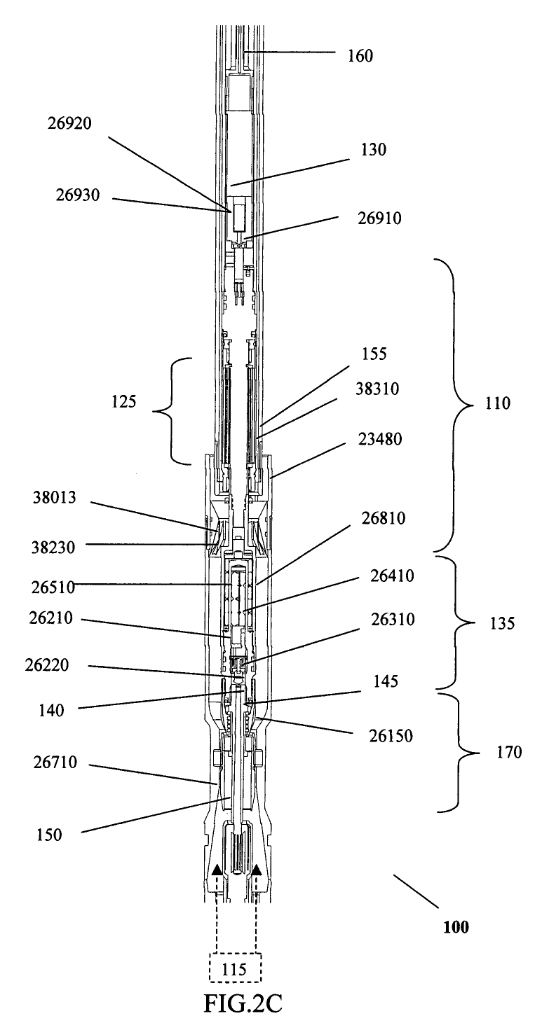

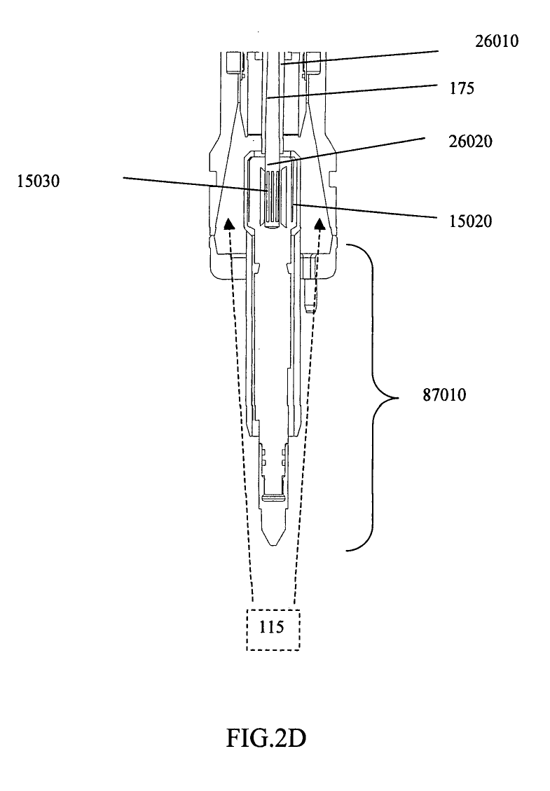

FIG. 2A shows a section starting with the fishing head assembly [15000] of the MWP/FTD [100] which allows fluid [115] to exit the MWP/FTD [100] in a near laminar flow, past the battery [71500] and around the fishing head assembly [15000].

FIG. 2B shows the section of the MWP/FTD [100] containing various instruments [160] and the motor [130]. Standard instrumentation, known to those skilled in the art, may include, but are not limited to, pressure transducers, gamma ray scintillation detectors and other useful instrumentation needed to identify the wellbore fluid, [115] flow, pressure and temperature from the lateral or other passages into the reservoir.

FIG. 2C shows the section of the MWP/FTD tool [100] including the motor [130], the coil assembly [125], the turbine [110], the poppet actuator assembly [135] and the pulser assembly [170]. The motor [130] is connected to the drive shaft [26910] via a drive shaft coupling [26930] or a worm gear [26920]. The drive shaft [26910] passes through the center of the coil assembly [125], turbine magnets [155], turbine shroud [38310] and is attached to the poppet actuator assembly [135]. The fluid [115], flowing through the flow guide [26710], rotates the turbine blade [38230] causing rotational motion of the turbine magnets [155] inside the turbine shroud [38310]. Electricity is generated in the coil assembly [125] which is fed back through the system to the various instruments [160] and to the battery [71500] for storage or for use when there is no fluid [115] flow.

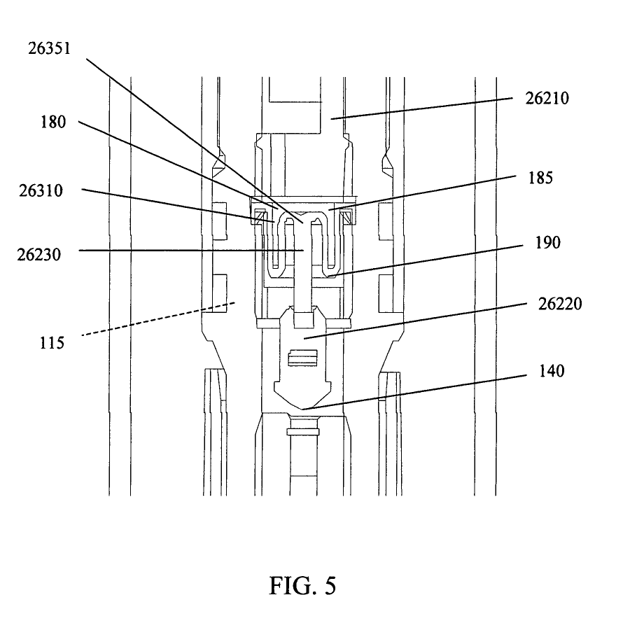

Further detail is indicated in FIG. 2C describing the MWP/FTD [100] which utilizes a turbine [110] residing near and within proximity of a flow diverter [38013]. The flow diverter [38013] diverts fluid [115] toward the annular drill collar flow channel [120] into and away from the turbine blade [38230] such that the force of the fluid [115] causes the turbine blade [38230] and turbine assembly [110] to rotationally spin around a coil assembly [125]. The coil assembly [125] generates electrical power for operating the motor [130] and other instrumentation [160] (FIGS. 1, 2B). The motor [130] comprises a worm gear [26920] or transmission system with fixed or adjustable gear ratios, a drive shaft [26910] centrally located between the motor [130] and the poppet actuator assembly [135] and mechanically coupled to both. Located in a position external to the magnetic pressure cup [26210] are outer magnets [26510] placed in relation to inner magnets [26410] located in a position inside the magnetic pressure cup [26210] forming a magnetic coupling. The coupling is for translating the rotational motion of the motor [130] and outer magnets [26510] to linear motion of the inner magnets [26410] via a magnetic polar interaction. The linear motion of the inner magnets [26410] moves the pilot [26220] into the pilot seat [140] closing the pilot seat orifice [145] lifting the flow throttling device [26150] into the flow throttling device orifice [150] thereby generating a pressure pulse. Further rotation of the motor [130], drive shaft [26910] and outer magnets [26510] move the inner magnets [26410] linearly inside the pilot actuator assembly [135] and pilot [26220] away from the pilot seat [140] causing the flow throttling device [26150] to move away from the flow throttling orifice [150] thereby generating a negative pressure pulse. The inner magnets [26410] are isolated from the drilling fluid [115] via a double rolling bellows [26310] which is described further in FIG. 5. A pulse in the fluid [115] is sensed uphole via a pressure transducer and/or other sound wave receivers and communicated, optionally with wireless devices, to a computer for interpretation and data transmission, reception and storage.

Additionally, further description of FIG. 2C shows the turbine [110] which resides within the annular flow channel [120] of the flow guide [23480]. The annular flow channel [120] may have special diverting vanes [38013] that direct the flow of the fluid [115] through and around the surface of the turbine [110]. The diverter vanes [38013] project from the flow guide extension [26710] in a fashion so as to direct the flow of the fluid [115] to move the turbine blade [38230] and attached turbine assembly [110] thereby changing the linear motion of the fluid [115] into rotational motion of the turbine assembly [110]. The turbine shroud [38310] contains magnets [155] that rotate with the motion of the turbine [110] around a coil assembly [125] causing electrical power to be generated for the operation of the motor [130]. The outside diameter of the turbine blade [38230] is smaller than the flow guide [23480] inner diameter, thereby allowing the turbine [110] to be removed concurrently with the pulser housing [26810] from the MWP/FTD [100]. The configuration of the turbine blade [38230] and flow diverter [38013] may be of various angles depending on the lateral passage conditions and needs of the pulsation rate (frequency) and magnitude (amplitude) for the MWP/FTD [100].

The velocity and consistency of the fluid [115] traveling through the annular flow channel [120] may vary due to lateral passage conditions generally providing varying forces on the turbine [110]. The varying forces cause the turbine [110] to spin at different velocities exhibiting a wide range of power to be developed by the coil assembly [125]. Fluctuations in the power are regulated through an electrical regulation circuit.

The motor [130] receives a signal from the electronics [160] that is onboard the MWP/FTD [100] to move the drive shaft [26910]. The motor [130] may be synchronous, asynchronous or stepper and is activated to fully rotate or to rotationally increment various degrees, depending on the lateral passage conditions or the observed signal intensity and/or duration.

FIG. 2D is a continuation of FIG. 2C including the stinger [87010]. In the open position, fluid [115] flows through the MWP/FTD [100] and through the mud screen outer screen [15020] and the mud screen inner screen [15030] into the guide pole channel [175], which is in the center of the pulser guide pole [26010]. In the MWP/FTD [100] closed position, the flow throttling device [26150] temporarily blocks the fluid [115] flow, thereby stopping fluid [115] and causing the pressure to rise in the fluid [115].

These conditions provide generation of a pulse as the MWP/FTD [100] reaches both the closed and opened positions. The present invention allows for several MWP/FTD's [100] (FIG. 1) to be placed in a lateral passage, thereby allowing for various pressure pulse amplitudes and/or frequencies and consequential exponential increases in the data rate.

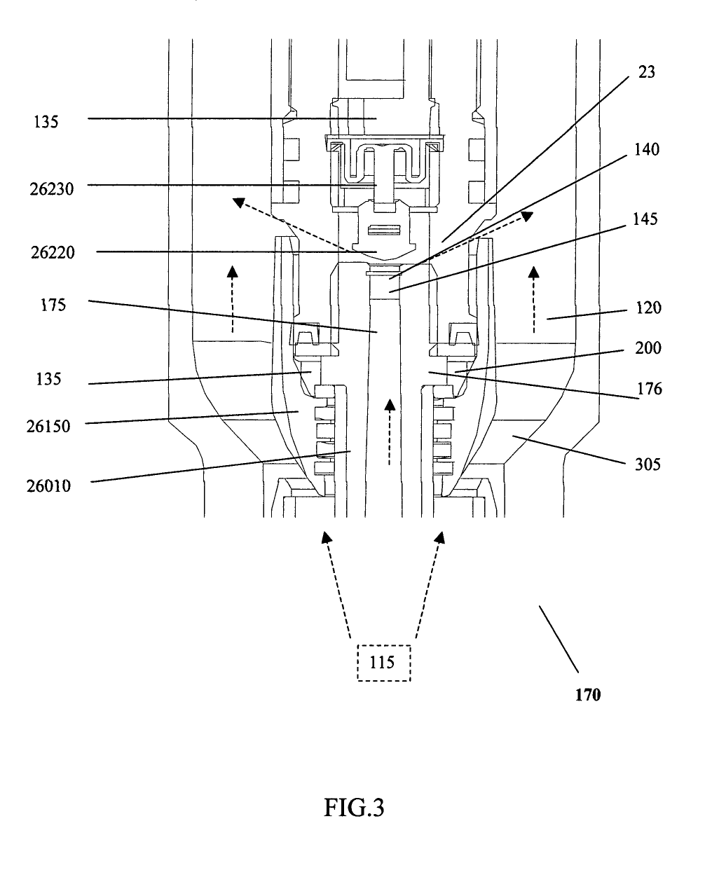

FIG. 3 shows the pulser assembly [170] in the closed position wherein the pilot actuator assembly [135] moves the pilot [26220] until it is in closed position with the pilot seat [140] so that no flow-through can occur. The front pilot shaft [26230] is the only portion of the pilot actuator assembly that moves the pilot [26220] in a translational or rotational direction.

For FIG. 3, when the pilot is in closed position, the guide pole channel [175] and the flow connecting channels [23] are effectively sealed so that fluid [115] flow is completely restricted through the pilot orifice [145]. As a seal is achieved, fluid [115] still enters both the guide pole channel [175] and separately, the connecting channels [176]. The fluid [115] flows through the guide pole channel [175] through the connecting channels [176] into the flow throttling device chamber [200] urging the flow throttling device [26150] to rise along the pulser guide pole [26010]. This effectively restricts the middle annular drill collar flow channel [305] from the lower annular drill collar flow channel [120], thereby generating a positive signal pulse at the throttle zone [14].

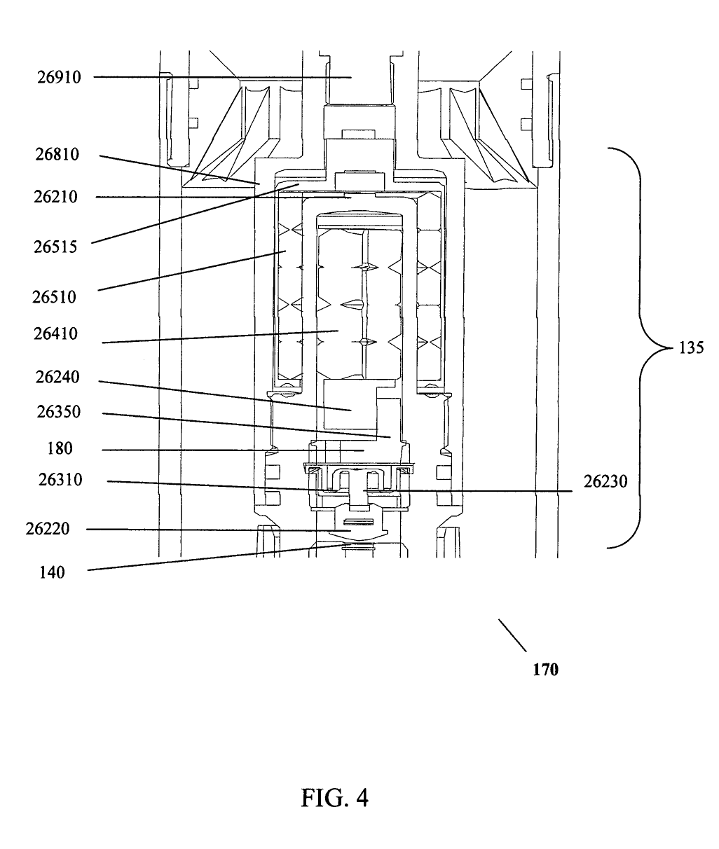

In FIG. 4, starting from the outside portion of the assembly and moving toward the center, the pulser assembly [170] comprises a pulser housing [26810] of a non-magnetic material, and a magnetic pressure cup [26210], which is also comprised of a non-magnetic material, and encompassed by the outer magnets [26510]. The outer magnets [26510] may comprise several magnets, or one or more components of magnetic or ceramic material exhibiting several magnetic poles within a single component. Additionally the magnetic pole positions may be customizable, depending on the well lateral passage conditions, to achieve a clear pressure signal. The outer magnets are housed in an outer magnet housing [26515] that is attached to the drive shaft [26910]. Within the magnetic pressure cup [26210] is housed the inner magnet assembly, that contains the rear pilot shaft [26240] linearly engaged to the front pilot shaft [26230], which is moved longitudinally within the center of the pulser assembly [170]. Within the magnetic pressure cup [26210] is a rear pilot shaft [26240], also comprised of non-magnetic material.

The outer magnets [26510] and the inner magnets [26410] are placed so that the magnetic polar regions interact, attracting and repelling as the outer magnets [26510] are moved about the inner magnets [26410]. Using the relational combination of magnetic poles of the moving outer magnets [26510] and inner magnets [26410], causes the inner magnets [26410] with the rear pilot shaft [26240], to move the front pilot shaft [26230] and the attached pilot [26220] linearly and interactively as a magnetic field coupling. The linear motion occurs along the rear pilot shaft [26240], through the front pilot shaft [26230] translates motion to the pilot [26220] thereby opening or closing the passage between the pilot [26220] and the pilot seat [140]. The use of outer magnets [26510] and inner magnets [26410] to provide movement from rotational motion to linear motion also allows the motor [130] (FIG. 2B) to operate in an atmospheric air environment in lieu of the use of a lubricating fluid [180] environment inside the magnetic pressure cup [26210]. This also allows for a decrease in the cost of the motor [130] (FIG. 2B), decreased energy consumption and subsequently decreased cost of the actual MWP/FTD [100] (FIG. 1).

Switching positive and negative fields between the outer magnets [26510] and the inner magnets [26410] provides a magnetic spring like action that allows for pressure relief by moving the pilot [26220] away from the pilot seat [140] thereby regulating the pulse magnitude. Additionally the outer magnets [26510] operate in the lower pressure of the pulser housing [26810] as opposed to the higher pressure within the magnetic pressure cup [26210], allowing for a greatly reduced need in the amount of energy required by the motor to longitudinally move the pilot actuator assembly [135].

The front pilot shaft [26230] passes through the anti-rotation block [26350] located near the bellows [26310]. The anti-rotation block [26350] is secured to the inside of the magnetic pressure cup [26210] and restricts the rotational movement of the front pilot shaft [26230].

Referring to FIG. 5, an embodiment of the bellows [26310] includes sealing a portion of the surface of the front pilot shaft [26230] engaged around a pilot shaft land [26351] and the interior of the hollow magnetic pressure cup [26210]. Sealing of the bellows [26310] keeps drilling fluid [115] from entering the bellows chamber [185] and intermingling with the inner magnet chamber lubricating fluid [180] when the pilot [26220] is moved to an open or closed position off the pilot seat [140]. Another embodiment is to allow the bellows [26310] to move linearly, concurrent with the front pilot shaft [26230]. The design of the bellows [26310] interacting with the front pilot shaft [26230] and the bellows chamber [185] allow the bellows [26310] to conform to the space constraints of the bellows chamber [185] providing flexible sealing without the bellows [26310] being displaced by the fluid [115]. It was also found that the double loop [190] configuration of the bellows [26310] consumes much less energy than previous designs thereby reducing the overall consumption of energy. Energy consumption is also reduced by pre-filling the bellows chamber [185] with appropriate lubricating fluid [180]. This allows for reduction of the pressure differential on both sides of the bellows [26310]. The smaller pressure differential enhances performance by the bellows [26310] and minimizes wear and energy consumption. The lubricating fluid [180] may be petroleum, synthetic or bio-based and should exhibit compression characteristics similar to hydraulic fluid. The double loop [190] configuration of the bellows is designed to minimize energy consumption.

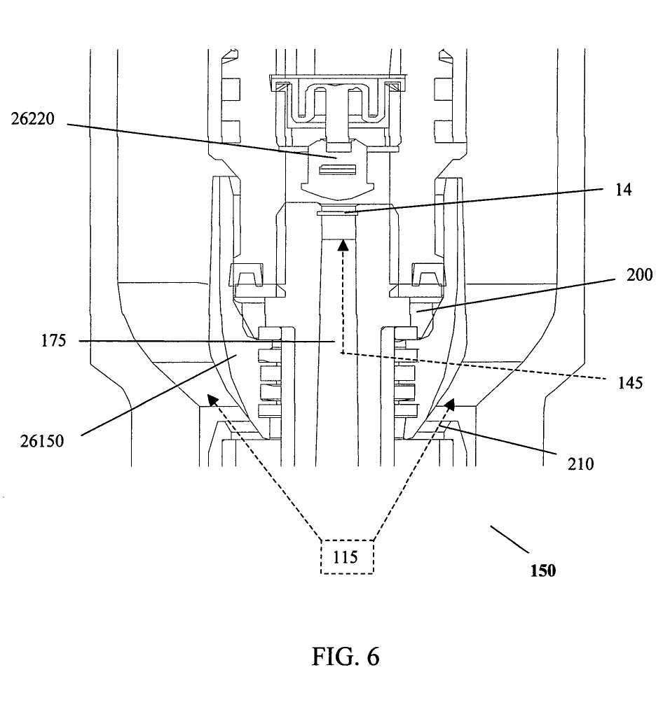

FIG. 6 shows another embodiment of the present disclosure pertaining to the configuration of the guide pole channel [175] and flow throttling device chamber [200] in the proximity of the pilot seat [140] and pilot seat orifice [145]. When the pilot [26220] is in contact with the pilot seat [140] the flow throttling device [26150] moves toward the flow throttling device seat [210]. Conversely (and inversely), when the pilot [26220] is not contacting the pilot seat [140] the flow throttling device [26150] withdraws from the flow throttling device seat [210]. The pressure differential between the fluid [115] pressure and the flow throttling device chamber [200] moves the flow throttling device [26150] more rapidly, enabling a very forceful restriction of the flow throttling device orifice [150] and a very defined pulse and therefore clearer signals which are more easily interpreted.

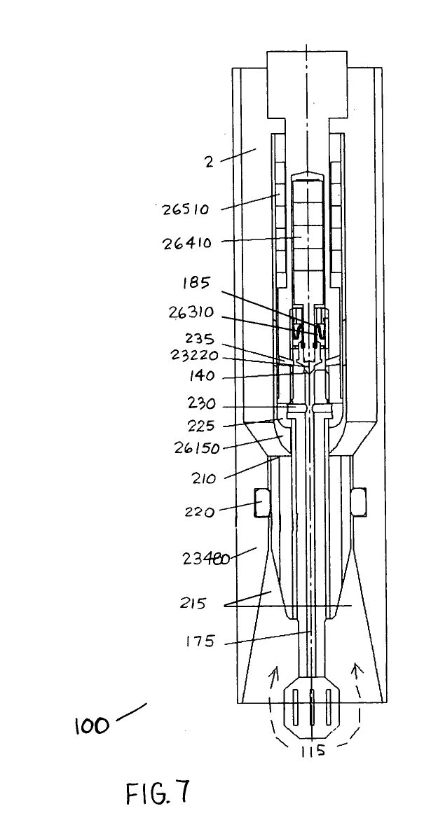

FIG. 7 is an alternate view of cross-section of a MWP/FTD [100] showing the MWP/FTD [100] with the pulser assembly [170], at the bottom and the fluid [115] flow from the bottom to the top of the drawing. The fluid [115] flows through the annular drill collar flow channel [2] into the flow guide [23480]. Internal to the flow guide [23480] is a guide pole [26010] which allows the flow throttling device [26150] to move axially along the guide pole [26010] where the flow throttling device [26150] will contact the flow throttling seat [210] thereby sealing off the outer annular flow channels [215]. The flow guide seal [220] keeps fluid [115] from flowing around the flow guide [23480] thereby ensuring that the fluid [115] only flows through the outer annular flow channels [215] and through the guide pole channel [175].

FIG. 7 also shows the flow throttling device [26150] in the open position and the pilot [23220] in the open position unseated from the pilot seat [140], where the flow throttling device [26150] is away from the flow throttling seat [210] allowing the flow throttling device pressure chamber [225] to drain the fluid [115] through the pilot connecting passage [230] via pilot input channels [235] and the annular drill collar flow channel [2]. In the closed position the pilot [23220] is seated on the pilot seat [140], and the flow throttling device [26150] is moved onto the flow throttling seat [210] allowing the flow throttling device pressure chamber [225] to fill with fluid [115], which causes the flow throttling device [26150] to move down within the flow guide [23480] due to hydraulic pressure caused by the fluid [115] exerting a hydraulic force acting on the flow throttling device [26150] in the flow throttling device pressure chamber [225]. The force acts to push the flow throttling device [26150] down within the flow guide [23480] and subsequently moves the outer magnets [26510] in the same direction. The outer magnets [26510] continue to move down and subsequently the opposing magnetic fields of the outer magnets [26510] pass the center of the magnetic fields of the inner magnets [26410]. The inner magnets [26410] attached to the pilot [23220] then, due to the magnetic fields, move in the opposite direction as the outer magnets [26510] causing the pilot [23220] to move up, in the same direction as the inner magnets [26410], thereby moving the pilot [23220] away from the pilot seat [140]. Movement of the pilot [23220] away from the pilot seat [140] allows for fluid [115] to exit through the pilot input channels [235] into the annular drill collar flow channel [2] thereby relieving pressure in the flow throttling device pressure chamber [225]. Release of this pressure causes the flow throttling device [26150] to reverse direction away from the flow throttling seat [210]. During the upward motion of the flow throttling device [26150] the outer magnets [26510] move upward thereby moving past the center of the magnetic fields of the inner magnets [26410] subsequently causing the inner magnets [26410] to move in an downward direction, again due to opposing magnetic fields. The downward movement of the inner magnets [26410] moves the pilot [23220] into the pilot seat [140] causing the flow throttling device pressure chamber [225] to refill to repeat the aforementioned cycle.

The outer magnets [26510] are stacked in position such that the fields are in opposition to each other. For example the stack top magnetic end is “N” and the bottom end is “S”. Moving down to the next magnet the field is “S” on the top and “N” on the bottom. Repeating the first sequence the top end is “N” and the bottom end is “S”. The inner magnets' [26410] fields are stacked similarly. The movement of the similar magnetic fields of the outer magnets [26510] to the inner magnets [26410] causes repulsion of the flow throttling device [26150] and the pilot [23220] basically holding the pilot [23220] in position until the outer magnet [26510] passes the center field of the opposing inner magnet [26410] which is an opposite pole and therefore repelled by the outer magnet [26510] causing the inner magnet [26410] to move in the opposite direction as the outer magnet [26510].

Additionally, the pilot [23220] is attached to the inner magnets [26410] and through a bellows [26310] which resides in a bellows chamber [185]. The bellows chamber [185] is filled with a viscous liquid and also acts as a dampening source for the pilot [23220].

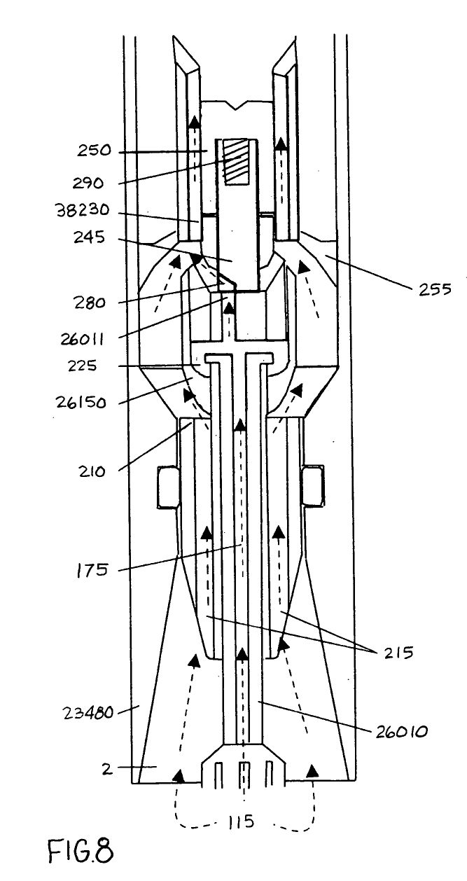

FIG. 8 shows a cross section of a MWP/FTD [100] where the fluid [115] (the dashed arrows indicate direction of flow) flows into the flow guide [23480] annular drill collar flow channel [2] and also into the guide pole [26010] in the pilot flow channel [175]. The flow throttling device [26150] in the open position allows the fluid [115] from the annular drill collar flow channel [2] to flow through the outer annular flow channels [215] into the bypass flow regulator [255]. When the pressure within the bypass flow regulator [255] is high enough, the flow throttling device [26150] moves up the guide pole [26010] to the flow throttling device seat [210] thereby creating a pressure pulse by closing off the outer annular flow channels [215]. The pressure in the bypass flow regulator [255] is released when the rotating pilot [245] rotated where the rotating valve flow bevel [280] is no longer conducting fluid [115] flow through the guide pole exit channel [26011]. When the flow throttling device [26150] is in the open position the fluid [115] flows unrestricted through the bypass flow regulator [255] and around the flow throttling device [26150]. Incoming fluid [115] from the annular drill collar flow channel [2] continues through the turbine blades [38230] thus rotating the rotating motor [250] and the rotating pilot [245]. Linear movement of the flow throttling device [26150] is caused by the fluid [115] that is moving through the rotating valve flow bevel [280], guide pole exit channel [26011] and through the guide pole channel [175].

The rotating valve [245] includes a feature noted as the rotating valve flow bevel [280] and is coupled to a rotating motor [250]. The rotating motor [250] provides rotational motion to the rotating valve [245]. The lower portion of the rotating valve [245] resides at the top of the guide pole [26010] and, upon rotation, allows the rotating valve flow bevel [280] to seal and unseal the guide pole exit channel [26011]. Sealing the guide pole exit channel [26011] forces the fluid [115] to flow into the flow throttling device pressure chamber [225] thereby hydraulically moving the flow throttling device [26150] down the guide pole [26010] until it contacts the flow throttling device seat [210] closing off the outer annular flow channels [215].

The rotating motor [250] rotates the rotating valve [245] such that the rotating valve flow bevel [280] passes the guide pole exit channel [26011] allowing for the fluid [115] in the flow throttling device pressure chamber [225] to evacuate, thereby reducing the hydraulic pressure acting on the flow throttling device [26150] and allowing the flow throttling device [26150] to move upward on the guide pole [26010] unsealing the outer annular flow channels [215].

Eventually the rotational motion of the rotating valve [245] moves the rotating valve flow bevel [280] past the guide pole exit channel [26011], sealing the guide pole exit channel [26011] and creating back pressure within the guide pole exit channel [26011] and refilling the flow throttling device pressure chamber [225].

Additionally there is a high pressure relief spring [290] that, should the rotating motor [250] fail, allows the rotating valve [245] to move away from the guide pole exit channel [26011] allowing fluid [115] to evacuate the flow throttling device pressure chamber [225].

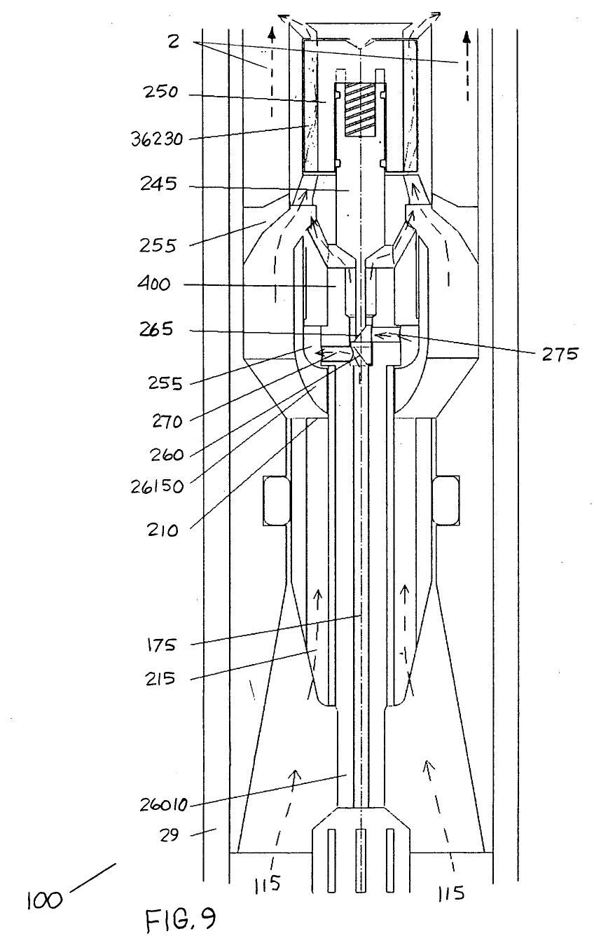

FIG. 9 shows a cross section of a MWP/FTD [100] in a drill collar [29] where the fluid [115] (the dashed arrows indicate direction of flow) flows from the outer annular flow channel [215] around the flow throttling device [26150] where the fluid [115] is separated into two different paths. One path goes through the turbine inlet channels {36230] into the turbine [28230] the other passes the bypass flow regulator [255] and continues through the annular drill collar flow channel [2].

The rotating valve [245] is positioned within inside the rotating valve chamber [400] which fills up with fluid [115]. Residing on the top end of the rotating valve [245] are two beveled valve sections described as a top angled cutout [260] and a bottom angled cutout [265]. The fluid [115] in the guide pole channel [175] within the guide pole [26010] contacts the top angled cutout [260] of the rotating valve [245] that is rotating due to the rotational movement of the rotating motor [250]. When the angle of the rotating top angled cutout [260] coincides with the chamber input channel [270] fluid [115] is allowed to enter the flow throttling device pressure chamber [225]. The fluid [115] then exerts a hydraulic pressure raising the flow throttling device [26150] until it contacts the flow throttling device seat [210] shutting off the flow of fluid [115] through the outer annular flow channels [215].

With the rotating valve [245] continuing to rotate, the bottom angled cutout [265] moves toward the chamber exhaust channel [275] eventually allowing the fluid [115] in the flow throttling device pressure chamber [225] to exit. The top angled cutout [260] then cooperates with the chamber input channel [270] sealing off any fluid [115] to the flow throttling device pressure chamber [225] through the guide pole channel [175] causing the flow throttling device [26150] to move away from the flow throttling device seat [210] and allowing fluid [115] to flow again through the outer annular flow channels [215]. The movement of the flow throttling device [26150] against and away from the flow throttling device seat [210] thereby allows for opening and closing the outer annular flow channels [215] to send a pressure pulse through the fluid [115].

When the flow throttling device [26150] is in the open position and not in contact with the flow throttling device seat [210] fluid [115] is allowed to pass unrestricted from the annular drill collar flow channel [2] through the outer annular flow channels [215] around the flow throttling device [26150]. The fluid [115] flows linearly from the annular drill collar flow channel [2] into the turbine blade [28230] where the turbine blade [28230] is caused to rotate by the linear flow of the fluid [115] thereby causing the motor [250] to rotate. The rotating motor [250] then rotates the rotating valve [245] with the flow throttling device [26150]. The rotating valve [245] has a top angled cutout [260] and a bottom angled cutout [265] that are located at the flow inlet end of the rotating valve [245] within the upper end of the guide pole [26010] and within the rotating valve chamber [400].

The top angled cutout [260] and the bottom angled cutout [265] are continuously rotated as part of the rotating valve [245] any time the fluid [115] flow is present across the turbine [28230]. Passage of the top angled cutout [260] and the bottom angled cutout [265] over the chamber inlet channel [270] and the chamber exhaust channel [275] act to provide a constantly intermittent flow of fluid [115] through the flow throttling device pressure chamber [225]. The rotational frequency of the top angled cutout [260] and the bottom angled cutout [265] over the chamber inlet channel [270] and the chamber exhaust channel [275] determine the pressure pulse duration and frequency. Rotational speeds (frequency) and pulse amplitudes (pressure pulse sizes) are variable, depending on the operator's settings and what is intended.

Additionally, the guide pole [26010] allows for the chamber inlet channel [270] and the chamber exhaust channel [275] to be linearly offset so that the top angled cutout [260] never aligns with the chamber exhaust channel [275] and in parallel, the bottom angled cutout [265] never aligns with the chamber inlet channel [270].

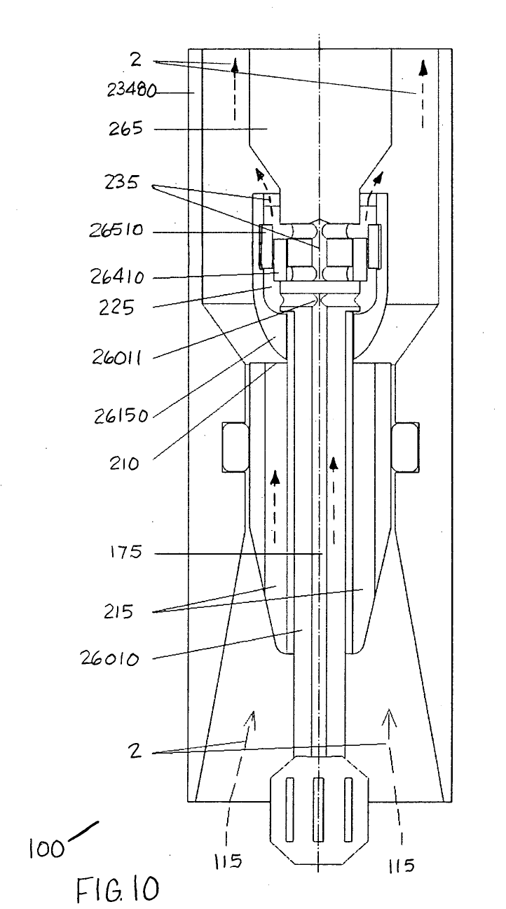

FIG. 10 is a cross section of a MWP/FTD [100] where the fluid [115] (the dashed arrows indicate direction of flow) flows into the annular drill collar flow channel [2] and through the outer annular flow channels [215]. When the flow throttling device [26150] is in the open position, fluid [115] from the annular drill collar flow channel [2] flows through the outer annular flow channels [215] and into the flow throttling device [26150]

The flow throttling device [26150] has, within and attached to it, an outer magnet [26510] which is arranged in detail as explained in FIG. 7. Inner magnets [26410] move axially along the guide pole [26010] to open and close the pilot exhaust channels [235]. When the flow throttling device [26150] moves up to the open position, the outer magnets [26510] flow throttling device [26150] moves up to the open position, the outer magnets [26510] attached to the flow throttling device [26150] move with the flow throttling device [26150] past the inner magnets [26410] causing the magnetic field of the outer magnets [26510] to repel the magnetic field of the inner magnets [26410] moving the inner magnets [26410] downward to close off the pilot exhaust channels [235]. The fluid [115] flowing into the pilot exhaust channels [235] filling the flow throttling device pressure chamber [225] creating a hydraulic pressure to urge the flow throttling device [26150] to down to closed position against the flow throttling device seat [210] thus closing off the outer annular flow channels [215]. The outer magnets [26510] attached to the flow throttling device [26150] move with the flow throttling device [26150] past the inner magnets [26410] causing the magnetic field of the outer magnets [26510] to repel the magnetic field of the inner magnets [26410] moving the inner magnets [26410] upward to open up the pilot exhaust channels [235] decreasing the hydraulic pressure in the flow throttling device pressure chamber [225] and allowing the flow throttling device [26150] to move upward to an open position and thus repeating the cycle.

Due to the arrangement of the magnetic poles at the ends of the magnets and their orientation within the flow throttling device [26150] the passing of the outer magnets [26510] by the inner magnets [26410] causes repelling of the inner magnets [26410] forcing downward movement thereby sealing the guide pole channel [175] from the flow throttling device pressure chamber [225]. In this position the inner magnets [26410] and inner magnet sleeve [295] allow for opening up the pilot exhaust channels [235] where pressure is relieved from the flow throttling device pressure chamber [225] and the flow throttling device [26150] is pushed up the guide pole [26010] moving the flow throttling device [26150] to move away from the flow throttling device seat [210].

Movement of the flow throttling device [26150] and outer magnets [26510] upward allows the outer magnets [26510] to travel past the inner magnets [26410] and inner magnet sleeve [295], magnetically attracting the inner magnets [26410] and moving the inner magnet sleeve [295] towards the openings of the flow throttling device pressure chamber [225]. The outer magnets [26510] moving up causes the inner magnets [26410] to move up to cover the pilot exhaust channels [135] opening up the guide pole channel [26011] to allow for filling of the flow throttling device pressure chambers [225]. As described in FIG. 9, the inner magnets [26410] with the inner magnet sleeve [295] act as a valve to open and close the flow throttling device pressure chamber [225] and the pilot exhaust channels [235].

We claim:

1. An apparatus for measuring and controlling fluid flow in a channel comprising:
a pulse generating device longitudinally and axially positioned within a flow channel such that a fluid/gas flowing through said flow channel is guided into two sets of selectively reversible flow, upper and lower flow connecting channels, wherein said connecting channels are connected to an inner flow channel and an annular pipe flow channel, and wherein said annular pipe flow channel is acted upon by one or more flow throttling devices thereby transmitting signals from pulses and also capable of controlling flow rate of said fluid flow and wherein said pulse generating device utilizes a turbine residing near and within proximity of a flow diverter that diverts said fluid flow in an annular flow channel into and away from turbine blades such that the force of said fluid flow causes said turbine blades and said turbine to rotationally spin around a coil assembly.

2. The apparatus of claim 1, wherein said apparatus for generating pulses includes said pilot actuator assembly comprised of a rear pilot shaft, front pilot shaft, and pilot, a pilot bellows, a flow throttling device, a sliding pressure chamber, and a pulser guide pole, wherein upper and lower inner flow connecting channels provide for reversal of flow and wherein said pilot seals a middle inner flow channel from said lower inner flow channel and such that said flow throttling device and said pilot are capable of bi-directional axial movement along or within said guide pole.

3. The apparatus of claim 1, wherein said coil assembly generates electrical power for recharging batteries and operating a motor and other operating equipment useful for instrumentation, said motor comprising a drive shaft centrally located between said motor and a magnetic pressure coupling wherein said motor and said coupling are mechanically coupled such that said motor rotates said magnetic pressure coupling outer magnets and moves said pilot actuator assembly.

4. The apparatus of claim 1, wherein a magnetic coupling is formed by a location external and internal to said magnetic pressure cup where outer magnets are placed in relation to inner magnets, said inner magnets located in a position inside said magnetic pressure cup, said coupling allowing for translating rotational motion of said motor and outer magnets to rotational or linear motion of said inner magnets via a magnetic polar interaction, wherein rotational or linear motion of said inner magnets move said pilot actuator assembly, thereby rotationally or linearly moving a pilot into a pilot seat, closing a pilot seat orifice, lifting a flow throttling device into a flow throttling orifice and thereby generating a pulse wherein a differential pressure is minimal in that a slight force acting on a small cross-sectional area of said pilot seat defines a pressure that is required to either engage or disengage said pilot, wherein further rotation of said motor drive shaft, and outer magnets move said pilot actuator assembly and said pilot away from said pilot seat causing said flow throttling device to move away from said flow throttling orifice, thereby ending the positive pulse.

5. The apparatus of claim 1, wherein said motor is connected to a drive shaft through a mechanical device including a worm gear, barrel cam face cam, or other mechanical means for converting the rotational motion of said motor into linear motion to propel said pilot actuator assembly.

6. The apparatus of claim 1, wherein said motor may be synchronous, asynchronous or stepper and is activated to fully rotate or to rotate incrementally in various degrees depending on wellbore or lateral passage(s) conditions and how much throttling is desired to control wellbore/pipe flow or pulsing thereby ensuring unaffected data transmission of the data stream.

7. The apparatus of claim 1, wherein said turbine resides within said annular flow channel of a flow guide and wherein said annular flow channel has diverting vanes that direct flow of fluid through and around a surface of said turbine.

8. The apparatus of claim 1, wherein said turbine includes a turbine shroud comprising turbine magnets that rotate with the motion of said turbine around said coil assembly causing electrical power to be generated for recharging rechargeable batteries and allowing for decreased battery requirements, a decrease in cost of said battery, decreased operational downtime, and subsequently decreased cost of said apparatus.

9. The apparatus of claim 1, wherein said turbine blades outside diameters around a pulser housing is smaller than a flow guide extension inner diameter, thereby allowing said turbine to be removed concurrently with said pulser housing.

10. The apparatus of claim 1, wherein said apparatus for generating pulses includes allowing a double loop configuration bellows to move linearly, concurrent with said pilot actuator assembly, wherein the design of said bellows interacts with said pilot actuator assembly and a bellows chamber allowing said bellows to conform to the space constraints of said bellows chamber providing flexible sealing without said bellows being displaced by the pressure differential created by said fluid flow and wherein pre-filling the bellows chamber with a lubricating fluid, gel or paste reduces energy consumption.

11. The apparatus of claim 1, wherein said pulse in said fluid flow is sensed by said instrumentation located uphole or downstream and wherein said pulse is communicated optionally with wireless devices, to a computer with a programmable controller for interpretation.

12. A method for generating pressure pulses during fluid flow and controlling said fluid flow comprising:
a pulse generating device longitudinally and axially positioned within an annular pipe flow channel such that said fluid/gas flows through said annular pipe flow channel and said fluid/gas is guided into two sets of selectively reversible flow, upper and lower flow connecting channels, wherein said connecting channels are connected to an inner flow channel and said annular pipe flow channel, and wherein said annular pipe flow channel is acted upon by one or more flow throttling devices thereby transmitting signals and controlling flow by throttling or closing off said fluid flow when pilot seat orifice is closed, wherein said device also utilizes a turbine residing near and within proximity of a flow diverter that diverts fluid flow in said annular flow channel into and away from turbine blades such that the force of the fluid causes said turbine blades and said turbine to rotationally spin around a coil assembly.

13. The method of claim 12, wherein apparatuses for generating pulses and controlling fluid flow includes said pilot actuator assembly comprised of a rear pilot shaft, front pilot shaft and pilot, a pilot bellows, a flow throttling device, a sliding pressure chamber, and a pulser guide pole, wherein upper and lower inner flow connecting channels provide for reversal of flow in said flow throttling device and wherein said pilot seals a middle inner flow channel from said lower inner flow channel such that said flow throttling device and said pilot are capable of bi-directional axial movement along said guide pole.

14. The method of claim 12, wherein said coil assembly generates electrical power for recharging batteries, and operating a motor and other operating equipment useful for instrumentation, said motor comprising a drive shaft centrally located between said motor and a magnetic pressure coupling wherein said motor and said coupling are mechanically coupled such that said motor rotates or linearly moves said magnetic pressure coupling outer magnets and moves said pilot actuator assembly, wherein said assembly opens and closes either a linear or rotational pilot valve.

15. The method of claim 12, wherein a magnetic coupling is formed by a location external and internal to said magnetic pressure cup where outer magnets are placed in relation to inner magnets, said inner magnets located in a position inside said magnetic pressure cup, said coupling allowing for translating rotational motion of said motor and outer magnets to rotational or linear motion of said inner magnets via a magnetic polar interaction, wherein rotational or linear motion of said inner magnets move said pilot actuator assembly, thereby rotationally or linearly moving a pilot into a pilot seat, closing a pilot seat orifice, lifting a flow throttling device into a flow throttling orifice and thereby generating a pulse wherein differential pressure is minimal in that a slight force acting on a small cross-sectional area of a pilot seat defines a pressure that is required to either engage or disengage said pilot, or controlling flow when said pilot seat is closed and wherein further rotation of said motor drive shaft and outer magnets move said pilot actuator assembly and said pilot away from said pilot seat causing said flow throttling device to move into said flow throttling orifice, thereby generating another pulse and/or controlling fluid flow.

16. The method of claim 12, wherein said motor is connected to a drive shaft through a mechanical device including a worm gear, barrel cam face cam, or other mechanical means for converting the rotational motion of said motor into linear motion to propel said pilot actuator assembly.

17. The method of claim 12, wherein said motor may be synchronous, asynchronous, or stepper and is activated to fully rotate or to incrementally rotate in various degrees depending on wellbore or lateral passage(s) conditions.

18. The method of claim 12, wherein said turbine resides within said annular flow channel of a flow guide and wherein said annular flow channel has diverting vanes that direct flow through and around a surface of said turbine.

19. The method of claim 12, wherein said turbine includes a turbine shroud comprising turbine magnets that rotate with the motion of said turbine around said coil assembly causing electrical power to be generated for recharging batteries and allowing for decreased battery requirements, a decrease in cost of said battery, decreased operational downtime, and subsequently decreased cost of said apparatus.

20. The method of claim 12, wherein said apparatus for generating pulses includes allowing a double loop configuration bellows to move linearly, concurrent with said pilot actuator assembly, wherein the design of said bellows interacts with said pilot actuator assembly and a bellows chamber allowing said bellows to conform to the space constraints of said bellows chamber providing flexible sealing without said bellows being displaced by the pressure differential created by the fluid flow wherein energy consumption may also be further reduced by pre-filling a bellows chamber with a lubricating fluid, gel or paste.

21. The method of claim 12, wherein said pulse of said fluid/gas flow is sensed by said instrumentation located within an uphole or downstream device and wherein said pulse is communicated optionally with wireless devices, to a computer with a programmable controller for interpretation.

22. A method for generating pressure pulses and controlling fluid/gas flow comprising a configuration including a guide pole channel and orifice chamber in the proximity of a pilot seat and pilot orifice wherein the diameter of said guide pole channel is smaller near said pilot seat and pilot orifice thereby creating a higher pressure in said guide pole channel than is exhibited by a fluid/gas flowing within a wellbore/pipe or lateral passage(s).

23. The method of claim 22, wherein said higher pressure creates a more discernable pulse with a flow throttling device when a pilot moves away from said pilot seat thereby permitting flow of fluid/gas through said pilot orifice or moving said pilot toward said pilot seat thereby closing said pilot orifice, wherein said pressure differential between the fluid/gas pressure and an orifice chamber moves said flow throttling device rapidly, thereby enabling forceful restriction of said fluid/gas flow through said flow throttling device orifice and little or no noise in a signal-to-noise ratio and wherein said pulses are extremely reproducible with corresponding signals that are readily defined uphole or downstream and wherein said fluid flow can be readily controlled.

24. Two or more apparatuses for generating pressure pulses and controlling fluid flow within a wellbore or lateral passage(s), comprising:
one or more pulse generating devices longitudinally and axially positioned within a flow channel such that a fluid flowing through said flow channel is guided into two sets of selectively reversible flow, upper and lower flow connecting channels, wherein said connecting channels are connected to an inner flow channel and an annular pipe flow channel, and wherein said annular pipe flow channel is acted upon by one or more flow throttling devices thereby transmitting signals from pulses and also capable of controlling flow rate of said fluid flow and wherein said pulse generating device utilizes a turbine residing near and within proximity of a flow diverter that diverts said fluid flow in an annular flow channel into and away from turbine blades such that the force of said fluid flow causes said turbine blades and said turbine to rotationally spin around a coil assembly generating electricity to run the system and/or recharge batteries.
